(19) United States
(12) Patent Application Publication
(10) Pub. No.: US 2018/0201852 A1
(43) Pub. Date: Jul. 19, 2018

(54) SYSTEM AND METHOD FOR CHEMICAL LOOPING

(71) Applicant: GENERAL ELECTRIC TECHNOLOGY GMBH, BADEN (CH)

(72) Inventors: FREDERIC VITSE, WEST HARTFORD, CT (US); DAVID TUREK, SOUTH WINDSOR, CT (US)

(73) Assignee: GENERAL ELECTRIC TECHNOLOGY GMBH, BADEN (CH)

(21) Appl. No.: 15/409,982

(22) Filed: Jan. 19, 2017

(51) Int. Cl. C10J 3/72; C01B 3/02

(52) U.S. Cl. CPC C10J 3/725; C01B 3/02; C10J 2300/1807; C10J 2300/0996; C10J 2300/0983; C10J 2300/093

(57) ABSTRACT

A method for chemical looping includes the steps of circulating a first oxygen carrier between a first oxidizer and a first reducer, circulating a second oxygen carrier between a second oxidizer and a second reducer, transporting a first gas stream produced via a reduction reaction in the first reducer from the first reducer to the second reducer, within the second reducer, capturing a gas species from the first gas stream, and recycling the gas species to the first reducer.

### GOVERNMENT RIGHTS

This invention was made with Government support under Contract Number DEFE0025073 awarded by the Department of Energy. The Government has certain rights in this invention.

### BACKGROUND

### Technical Field

Embodiments of the invention relate generally to power generation and, more particularly, to a system and method for improving the efficiency and reducing emissions of a chemical looping system.

### Discussion of Art

Chemical looping systems utilize a high temperature process whereby solids such as calcium or metal-based compounds, for example, are “looped” between a first reactor, called an oxidizer, and a second reactor, referred to as a reducer. In the oxidizer, oxygen from injected air is captured by the solids in an oxidation reaction. The captured oxygen is then carried by the oxidized solids to the reducer to be used for combustion or gasification of a fuel such as coal. After a reduction reaction in the reducer, the reacted solids, and, potentially, some unreacted solids, are returned to the oxidizer to be oxidized again, and the cycle repeats.

In the combustion or gasification of a fuel, such as coal, a product gas is generated. This gas typically contains pollutants such as carbon dioxide (CO₂), sulfur dioxide (SO₂) and sulfur trioxide (SO₃). The environmental effects of releasing these pollutants to the atmosphere have been widely recognized, and have resulted in the development of processes adapted for removing the pollutants from the gas generated in the combustion of coal and other fuels.

Referring to FIG. 1, a typical calcium-based chemical looping system 10 of a chemical looping-based power plant according to an exemplary embodiment is illustrated. The system 10 includes a first loop having a reducer 12, and a second loop having an oxidizer 14. Air 16 is supplied to the oxidizer 14, and calcium sulfide (CaS) is oxidized therein to produce a calcium sulfate (CaSO₄). The CaSO₄ is supplied to the reducer 12, and acts as a carrier to deliver oxygen and heat to fuel 18 (such as coal, for example) supplied to the reducer 12. As a result, the oxygen delivered to the reducer 12 interacts with the coal 18 in the reducer 12. Reduced CaS, is then returned to the oxidizer 14 to again be oxidized into CaSO₄, and the cycle described above repeats. Flue gas including nitrogen gas (N₂) 20, extracted from the oxidizer by a gas/solids separation device such as a cyclone, as well as heat resulting from the oxidation, exit the oxidizer 14 through a standpipe and seal device to either return to the oxidizer or reducer. Likewise, a gas 22 produced during reduction in the reducer 12 exits the reducer 12.

As shown in FIG. 1, while air 16 is supplied to the oxidizer 14, as described above, waste 20 such as ash and/or excess calcium sulfate (CaSO₄), are removed from the oxidizer 14 for disposal in an external facility (not shown). The coal 18, as well as calcium carbonate (CaCO₃) 24 and recirculated steam 26, are supplied to the reducer 12 for a reduction reaction therein.

In operation, a series reduction reaction occurs within the reducer 12 among oxygen from the oxygen carrier and the coal 18, the CaCO₃ 24, and CaSO₄ 28, and produces calcium sulfide (CaS) 30, which is separated by a gas/solids separator 32, such as a cyclone separator 32, and is thereafter supplied to the oxidizer 14 through, for example, a seal pot control valve (SPCV) 34. A portion of the CaS and other solids 30, based upon CL plant load, for example, is recirculated to the reducer 12 by the SPCV 34, as shown in FIG. 1. In addition, the separator separates the flue gas 22, e.g., CO₂ and other emissions such as SO₂ from the CaS 30.

The CaS 30 is oxidized in an oxidation reaction in the oxidizer 14, thereby producing the CaSO₄ 28 which is separated from flue gas 20 by a separator 32 and is supplied back to the reducer 12 via a SPCV 34. A portion of the CaSO₄ 28 and CaS may be recirculated back to the oxidizer 14 by the SPCV 34 based upon CL plant load, for example. The oxidation reaction also produces heat which can be utilized in other processes. For example, as illustrated in FIG. 1, in an embodiment, a thermal loop 100 may be integrated with the system 10 to generate power. In particular, the heat produced by the oxidation reaction can be utilized in a steam/water generating device 102 to generate steam 104 which is then used to drive a steam turbine 106 which, in turn, drives a power generator 108.

Existing chemical looping systems typically require significant post-combustion treatment systems for limiting emissions of particulate matter and certain gas species such as CO₂, SO₂, SO₃. Moreover, oxygen carrier cyclic capacity is known to degrade as side reactions releasing SO₂ occur under cyclic conditions between a reducer and an oxidizer. This same release, however, is also responsible for the fast kinetics of oxidization of the fuel in the reducer.

In view of the above, there is a need for a chemical looping system that minimizes the need for post-combustion treatment of combustion gases, reduces emissions, and reduces overall oxygen demand of the system.

### BRIEF DESCRIPTION

In an embodiment, a method for a chemical looping system is provided. The method includes the steps of circulating a first oxygen carrier between a first oxidizer and a first reducer, circulating a second oxygen carrier between a second oxidizer and a second reducer, transporting a first gas stream produced via a reduction reaction in the first reducer from the first reducer to the second reducer, within the second reducer, capturing a gas species from the first gas stream, and recycling the gas species to the first reducer.

In another embodiment, a method for a chemical looping system is provided. The method includes the steps of circulating a first oxygen carrier between an oxidizer and a first reducer, circulating a second oxygen carrier between the oxidizer and a second reducer, transporting a first gas stream produced via a reduction reaction in the first reducer from the first reducer to the second reducer, within the second reducer, with the second oxygen carrier, capturing a gas species from the first gas stream, and transporting the second oxygen carrier from the second reducer to the oxidizer.

In yet another embodiment, a system for chemical looping is provided. The system includes a first reducer in which a fuel reacts with a first oxygen carrier, a second reducer in fluid communication with the first reducer and receiving a combustion gas stream therefrom, and in which at least one gas species in the combustion gas stream reacts with a second oxygen carrier, and at least one oxidizer in fluid communication with the first reducer and the second reducer for supplying the first oxygen carrier to the first reducer and the second oxygen carrier to the second reducer after an oxidizing reaction in the oxidizer.

### DRAWINGS

The present invention will be better understood from reading the following description of non-limiting embodiments, with reference to the attached drawings, wherein below:

FIG. 1 is a schematic illustration of a prior art chemical looping system.

FIG. 2 is a schematic illustration of a portion of a dual-loop chemical looping system according to an embodiment of the invention.

FIG. 3 is a graph illustrating product gas oxidation within a second reducer of the dual-loop chemical looping system of FIG. 2.

FIG. 4 is a graph illustrating SO₂ capture and reduction achieved by the dual-loop chemical looping system of FIG. 2.

FIG. 5 is a schematic illustration of a portion of a chemical looping system according to another embodiment of the invention.

FIG. 6 is a schematic illustration of a portion of a chemical looping system according to another embodiment of the invention.

FIG. 7 is a schematic illustration of a portion of a chemical looping system according to another embodiment of the invention.

FIG. 8 is a schematic illustration of a portion of a chemical looping system according to another embodiment of the invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts. While embodiments of the invention are suitable for use in a power generation process, other applications are also contemplated including but not limited to gasification processes such as, but not limited to, those used to produce syngas and those used to sequester carbon dioxide.

As used herein, “operatively coupled” refers to a connection, which may be direct or indirect. The connection is not necessarily a mechanical attachment. As used herein, “fluidly coupled” or “fluid communication” refers to an arrangement of two or more features such that the features are connected in such a way as to permit the flow of fluid between the features and permits fluid transfer. As used herein, “solids” means solid particles intended for use in a combustion process or a chemical reaction such as, for example, coal particles or a metal oxide (e.g., calcium).

Embodiments of the invention relate to a chemical looping system and method that employs a coupled, dual reduction-oxidation block through which solids are circulated. The system and method utilize, for example, selective catalytic reduction of sulfur dioxide in a second reduction-oxidation loop to enhance the performance of the process. In an embodiment, the method utilizes the recycling and release of sulfur dioxide in a primary reducer to enhance both kinetics of the reaction with a fuel supplied to the primary reducer and the oxygen cyclic capacity. In particular, selective catalytic reduction of sulfur dioxide allows for both sulfur recapture and reduced oxygen demand of the product gas stream from the reduction reaction(s) in the reducer.

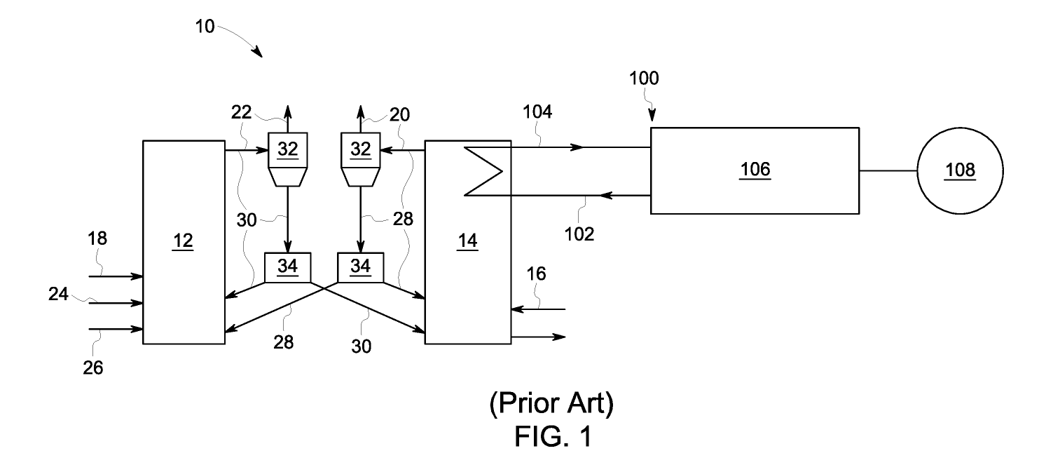

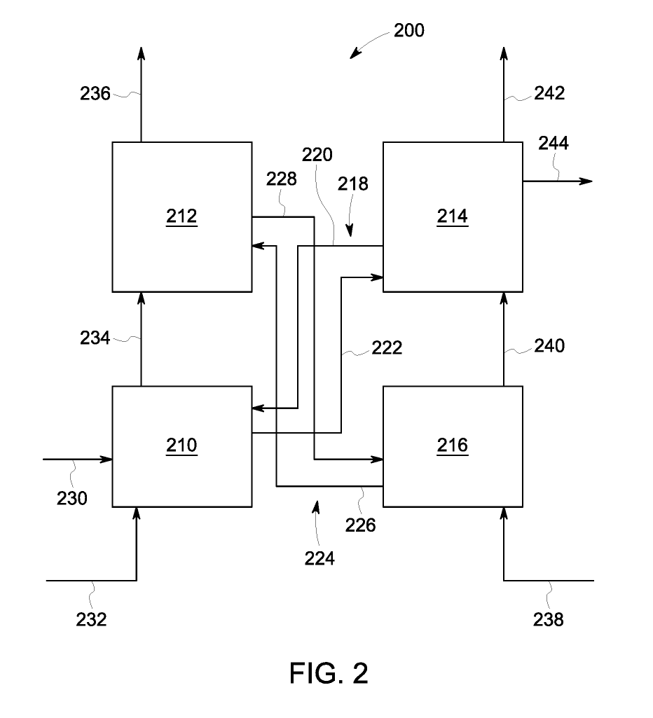

With reference to FIG. 2, a reduction-oxidation block 200 of a dual-loop chemical looping system according to an embodiment of the invention is illustrated. The dual reduction oxidation block 200 may form a part of a chemical looping system, such as chemical looping system 10, shown in FIG. 1. As discussed in detail, hereinafter, however, rather than employing a single oxidizer and a single reducer defining a single solids flow loop as shown in FIG. 1, the chemical looping system of the invention utilizes dual oxidizers and dual reducers defining two loops. In particular, as shown in FIG. 1, the dual reduction-oxidation block 200 includes a first reducer 210 (i.e., first reducing reactor) and a second reducer 212 (i.e., second reducing reactor), which can effect reduction reactions, and a first oxidizer 214 (i.e., first oxidizing reactor) and a second oxidizer 216 (i.e., second oxidizing reactor), which can effect oxidation reactions. Suitable reactors include, for example, transport reactors and fluidized bed reactors.

As shown in FIG. 2, the first reducer 210 and first oxidizer 214 are in fluid communication with one another and define together a first loop 218 for circulating a first oxygen carrier therebetween. In particular, oxidized solids 220 (i.e., the first oxygen carrier after an oxidation reaction in the first oxidizer 214) are transported to the first reducer 210. The oxidized solids 220 are then reduced in the first reducer 210, and the reduced solids 222 (i.e., the first oxygen carrier after a reduction reaction in the first reducer 210) are transported back to the first oxidizer 214 for re-oxidation.

Similarly, the second reducer 212 and second oxidizer 216 are in fluid communication with one another and define together a second loop 224 for circulating a second oxygen carrier therebetween. In particular, oxidized solids 226 (i.e., the second oxygen carrier after an oxidation reaction in the second oxidizer 216) are transported to the second reducer 212. The oxidized solids 226 are then reduced in the second reducer 212, and the reduced solids 228 (i.e., the second oxygen carrier after a reduction reaction in the second reducer 212) are transported back to the second oxidizer 216 for re-oxidation.

Additionally, as shown in FIG. 2, fluid communication is provided between the first reducer 210 and the second reducer 212, as well as between the first oxidizer 214 and the second oxidizer 216, the purpose of which will be discussed below. As is known in the art, the first reducer 210 is configured to be supplied with a fuel 230 such as, for example, coal, as well as gasification gases 232 (e.g., CO₂, H₂O, SO₂, etc.). The gasification gases 232 react with the fuel 230 and the oxidized first oxygen carrier 220 provided from the first oxidizer 214. In an embodiment, the first oxygen carrier is a calcium-based oxygen carrier such as, for example, limestone. In an embodiment, the first oxygen carrier comprises at least partially sulfated limestone.

In particular, in an embodiment, the sulfated limestone (e.g., a CaSO₄/CaO blend) reacts with the products of fuel gasification to form a CaSO₄/CaS/CaO blend. In the process of being at least partially reduced, CaSO₄ produces some SO₂ in the gas phase, which is provided in product/combustion gas stream 234 from the first reducer 210 to the second reducer 212. In an embodiment, the gas stream 234 may include, for example, unconverted products of gasification (e.g., CO, H₂, CH₄, etc.), products of combustion (e.g., CO₂, H₂O) as well as SO₂.

In the second reducer 212, selective catalytic reduction takes place between SO₂ and the unconverted product of gasification (CO, H₂, CH₄). In particular, selective catalytic reduction takes place on the oxidized second oxygen carrier 226 supplied to the second reducer 212 from the second oxidizer 216. In an embodiment, the second oxygen carrier is a metal oxide such as, for example, ilmenite. In the second reducer 212, SO₂ is reduced and adsorbed to the surface of the second oxygen carrier. Therefore, in the second reducer 212, the gas product of the first reducer 210 is further oxidized while SO₂ is reduced, thus reducing both the oxygen demand of the product gas and the SO₂ content from product gas stream 236.

After the SO₂ is reduced and adsorbed to the surface of the second oxygen carrier, the reduced second oxygen carrier 228 is then circulated to the second oxidizer 216 where it is re-oxidized, while adsorbed sulfur-containing species are desorbed in the gas in the form of SO₂. Air (or other oxidizing streams) 238 are fed to the second oxidizer 216, as shown in FIG. 2. Gas steam 240 exits the second oxidizer 216 loaded with SO₂ and enters the first oxidizer 214 where the limestone-based oxygen carrier 222 in the first loop 218 recaptures the SO₂ via an oxidation reaction and recirculates it to the first reducer in the form of the CaSO₄/CaO blend. Beginning again with the first reducer 210, the cycle is repeats.

The dual-loop chemical looping system of the invention ensures that SO₂ is at least partially recycled around the system, thus allowing for an increased concentration of SO₂ in the first reducer 210 while maintaining a relatively low SO₂ concentration in emission streams 236, 242 existing the second reducer 212 and first oxidizer 214, respectively. Sulfur mass balance is achieved in the system 200 through a purge stream 244 exiting the first oxidizer 214. This process allows for unmixed first and second oxygen carriers to be purged independently. In an embodiment where coal is utilized as the fuel 230, excess sulfur may be purged with the ashes. In an embodiment, the first oxygen carrier can be recycled around the first oxidizer 214 to increase the sulfur content of the sulfated limestone. Moreover, since the first oxygen carrier in its oxidized form does not contain any sulfur, the removal of SO₂ in the second reducer 212 can be tuned to targeted SO₂ enrichment in the system.

In addition to the above, in an embodiment, SO₂ concentration in the first reducer 210 can be controlled to adjust the oxygen cyclic capacity of the first oxygen carrier within the first loop 218 and corresponding conversion of the solid fuel. In an embodiment, the circulation rate of the second oxygen carrier within the second loop 224 can be tuned to adjust both the oxygen demand and the SO₂ concentration leaving the system.

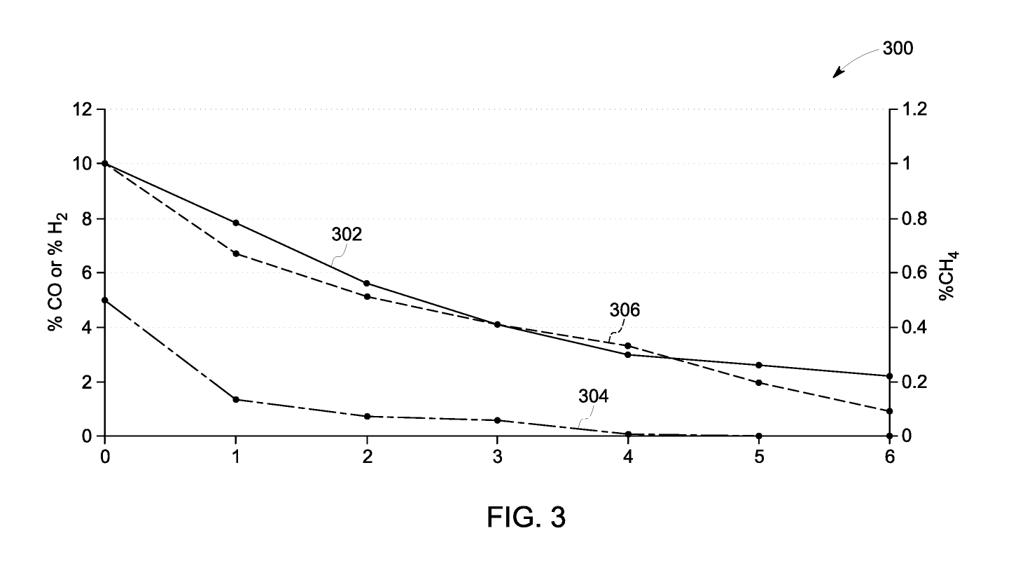

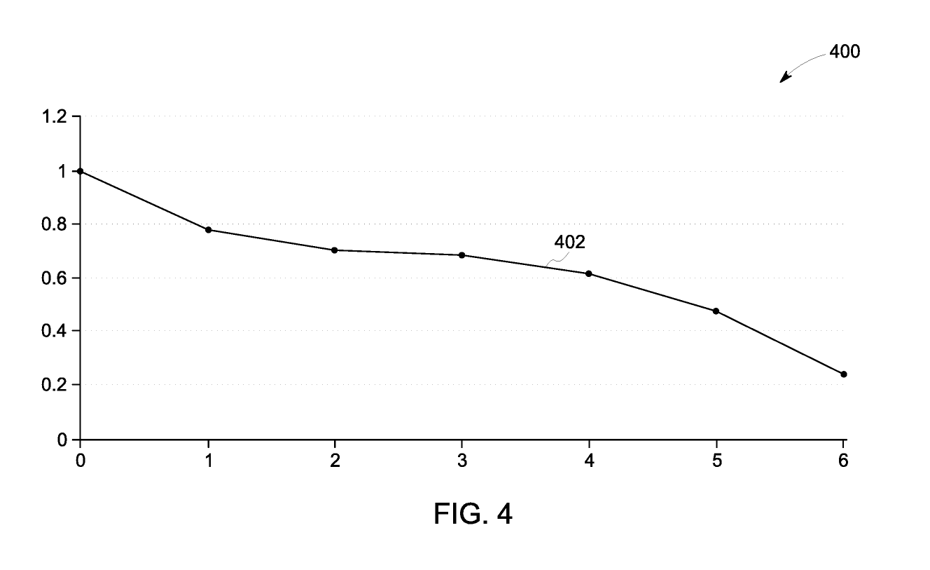

FIGS. 3 and 4 are graphs illustrating the reduction in the oxygen demand of the product gas, as well as SO₂ capture and reduction achieved by the invention. For example, FIGS. 3 and 4 are graphs 300, 400, respectively, showing the result of product gas oxidation in the second reducer 212 utilizing sulfated limestone, as a function of units of bed depth (where bed depth is estimated at approximately 6 inches with a gas residence time per bed of 0.2). As illustrated in FIG. 3, CO volume percent is indicated by line 302, H₂ volume percent is indicated by line 304, and CH₄ volume percent is indicated by line 306. As shown in FIG. 3, the oxygen demand of the product gas has been show to have been reduced by approximately 90%. As shown in FIG. 4, SO₂ volume percent is indicated by line 402, and illustrates a marked reduction in SO₂ as it is captured by the second oxygen carrier in the second reducer 212.

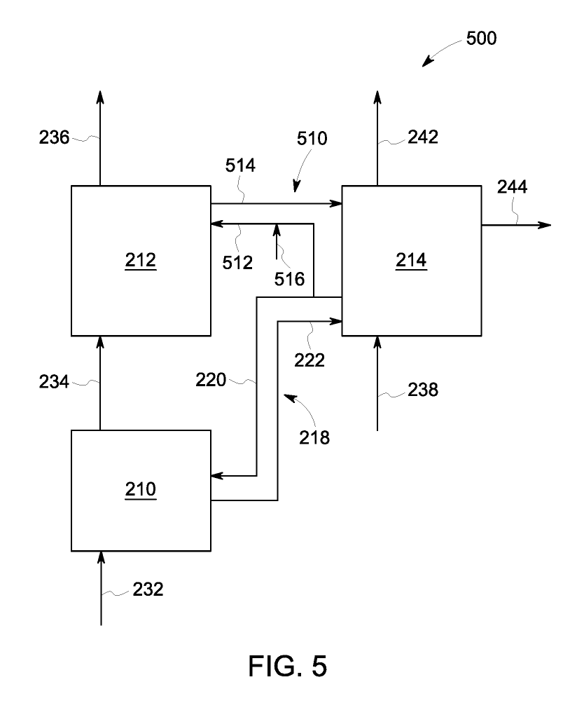

Referring now to FIG. 5, a reduction-oxidation block 500 of a chemical looping system according to another embodiment of the invention is illustrated. As shown therein, the system is generally similar to that described above in connection with FIG. 2, where like numerals designate like parts. Rather than utilizing a second oxidizer and a separate second oxygen carrier, however, the same oxygen carrier is utilized for injection into both the first reducer 210 and the second reducer. In an embodiment, the oxygen carrier that is used to carry oxygen to both the first reducer 210 and the second reducer 212 may be limestone. As illustrated in FIG. 5, the system includes the first reducer 210 (i.e., first reducing reactor) and the second reducer 212 (i.e., second reducing reactor), which can effect reduction reactions, and an oxidizer 214 (i.e., oxidizing reactor), which can effect oxidation reactions.

As shown in FIG. 5, the first reducer 210 and oxidizer 214 are in fluid communication with one another and define together a first loop 218 for circulating a first oxygen carrier therebetween. In particular, a first portion of oxidized solids 220 (i.e., the first oxygen carrier after an oxidation reaction in the oxidizer 214) is transported to the first reducer 210. The oxidized solids are then reduced in the first reducer 210, and the reduced solids 222 (i.e., the oxygen carrier after a reduction reaction in the first reducer 210) are transported back to the first oxidizer 214 for re-oxidation. Like the system 200 of FIG. 2, fluid communication is provided between the first reducer 210 and the second reducer 212 of the system 500 of FIG. 5.

As further shown therein, the second reducer 212 and the oxidizer 214 are in fluid communication with one another and define together a second loop 510 for circulating the oxygen carrier therebetween. In particular, a second portion of the oxidized solids 512 (i.e., the oxygen carrier after an oxidation reaction in the oxidizer 214) are transported to the second reducer 212. The oxidized solids 512 are then reduced in the second reducer 212, and the reduced solids 514 (i.e., the oxygen carrier after a reduction reaction in the second reducer 212) are transported back to the oxidizer 214 for re-oxidation.

In operation, limestone is injected in the second reducer 212 and cycled between the second reducer 212 and the oxidizer 214, accumulating captured SO₂ as calcium sulfate. One feature of this configuration is that the solid feed and return of the second reducer 212 is mostly free of solid fuel and therefore no further gasification can occur in the second reducer 212, leading to a significantly reduced oxygen demand in the product gas 236. In an embodiment, limestone make up 516 for the process is at least partially injected in the solid feed 512 of the second reducer 212 to control sulfur capture and the concentration of sulfated lime in the second loop 510.

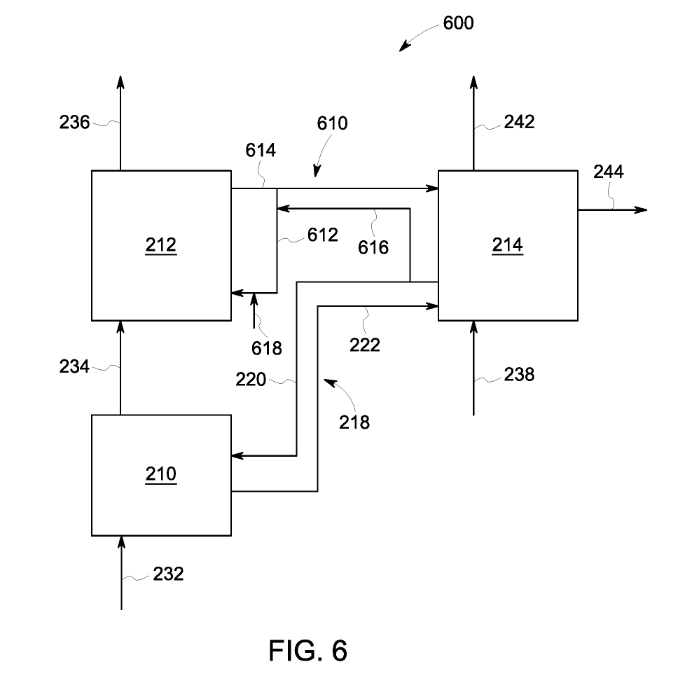

Referring now to FIG. 6, a reduction-oxidation block 600 of a chemical looping system according to another embodiment of the invention is illustrated. As shown therein, the system is generally similar and functions similarly to the system 500 FIG. 5, where like numerals designate like parts. As illustrated therein, however, the second loop 610 for circulating the oxygen carrier (e.g., limestone) between the second reducer 212 and the oxidizer 214 includes a solids recycle leg 612. In operation, a first portion of the reduced solids 614 (i.e., the oxygen carrier after a reduction reaction in the second reducer 212) is provided directly back to the oxidizer 214 for re-oxidation, while a second portion of the reduced solids 614 is recycled back to the second reducer 212 through recycle leg 612. In addition, as shown in FIG. 6, the portion of the oxidized solids 616 (i.e., the oxygen carrier after an oxidation reaction in the oxidizer 214) utilized in the second reducer 212 are not provided directly to the second reducer 212, but are mixed with the recycled solids in recycle leg 614 before entering the second reducer 212. In an embodiment, limestone make up 618 for the process is at least partially injected in the recycle leg 612 to control sulfur capture and the concentration of sulfated lime in the second loop 610.

In operation, limestone is injected into the recycle leg 612 of the second reducer 212 and cycled between the second reducer 212 and the oxidizer 214, accumulating captured SO₂ as calcium sulfate. As indicated above, however, a portion of the oxygen carrier on its way to the oxidizer 214 for re-oxidation is recycled to the second reducer 212. This configuration provides an increased level of SO₂ capture.

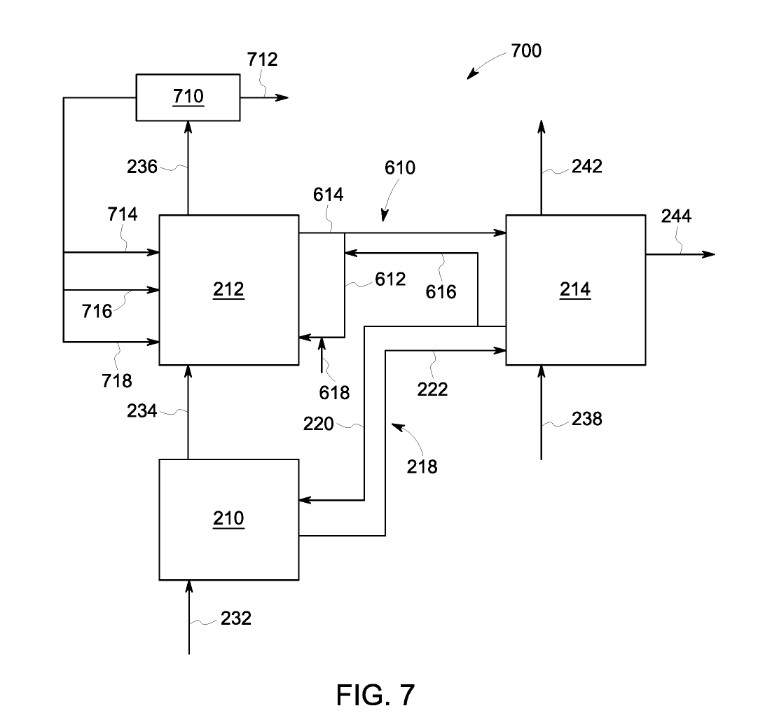

Referring to FIG. 7, a reduction-oxidation block 700 of a chemical looping system according to another embodiment of the invention is illustrated. As shown therein, the system is generally similar and functions similarly to the system 600 FIG. 6, where like numerals designate like parts. As illustrated in FIG. 7, the system 700 additionally includes a gas processing unit 710 integrated with the second reducer 214. The gas processing unit 710 is configured to separate CO₂ from the product gas 236 of the second reducer 212 such as by means known in the art. A portion 712 of the separated CO₂ can be sequestered for downstream use. The remainder of the separated product gases (which included unburnt reduced species) can be injected/recycled back into the second reducer 212 at different elevations/locations (denoted by lines 714, 716, 718) to maximize SO₂ capture while minimizing the oxygen demand leaving the second reducer 212. In an embodiment, steam may be injected in gas stream 234 or product gas stream 236.

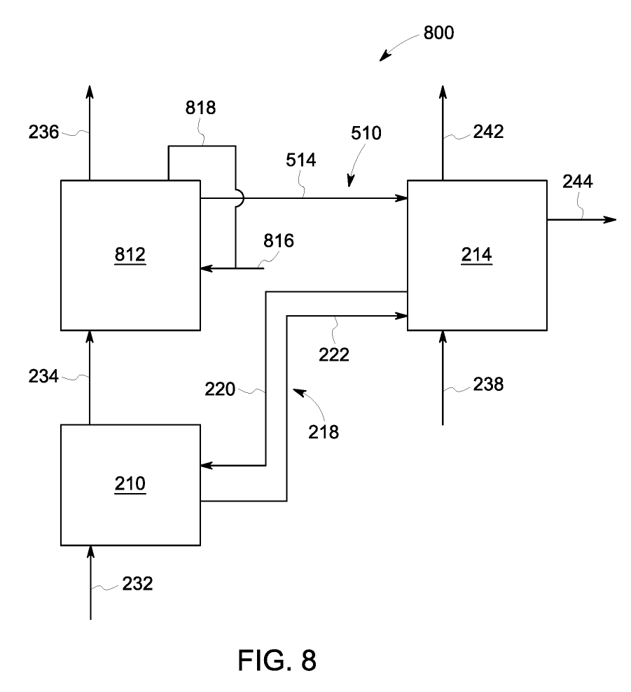

Referring finally to FIG. 8, a reduction-oxidation block 800 of a chemical looping system according to another embodiment of the invention is illustrated. As shown therein, the system is generally similar to that described above in connection with FIG. 5, where like numerals designate like parts. As shown therein, rather than employing a second reducer 212 as shown in FIG. 5, the system 800 utilizes a dry flue gas desulfurization system 812 such as for example, the NID system/technology developed by Alstom/General Electric.

As shown in FIG. 8, the first reducer 210 and oxidizer 214 are in fluid communication with one another and define together a first loop 218 for circulating a first oxygen carrier therebetween. As also shown therein, makeup solids 816 (e.g., limestone) for use as an oxygen carrier and for capturing SO₂ are injected into the dry flue gas desulfurization system 812 at 816, and are recycled to the dry flue gas desulfurization system 812 through pathway 818. In an embodiment, dry flue gas desulfurization system 812 operates at a lower temperature than the first reducer 210 (the dry flue gas desulfurization system and first reducer may be close in temperature and operate, for example, between about 1700° F. and about 1900° F.), and is not used to further reduce the oxygen demand, but rather to recapture SO₂ at low temperature. The solids captured (loaded with recaptured SO₂) in the dry flue gas desulfurization system 812 would then be recycled to the oxidizer through pathway 514 after being heated up (only a small fraction of total solids circulating in the main loop is required to recapture SO₂ in the second reactor 212).

As illustrated in FIG. 8, the sulfur loop between the reducer 210 and the oxidizer 214 is closed, allowing all the benefits described above, but no longer further reduce the oxygen demand, which would be taken care of by recycling the separated product gas from, for example, a gas processing unit (e.g., the gas processing unit shown in FIG. 7 and receiving product gas stream 236) to the first reducer 210 (rather than second reducer 212 as shown in FIG. 7, which does not exist in the system 800 of FIG. 8).

Embodiments of the invention therefore provide a chemical looping system and method that employs a coupled, dual reduction-oxidation block through which solids are circulated. The system and method utilize, for example, selective catalytic reduction of sulfur dioxide in a second reduction-oxidation loop to enhance the performance of the process. In an embodiment, the method utilizes the recycling and release of sulfur dioxide in a primary reducer to enhance both kinetics of the reaction with a fuel supplied to the primary reducer and the oxygen cyclic capacity, as discussed above. In particular, selective catalytic reduction of sulfur dioxide allows for both sulfur recapture and reduced oxygen demand of the product gas stream from the reduction reaction(s) in the reducer(s). The system and method of the invention provide for the use of a low cost oxygen carrier, namely limestone, fast kinetics of oxidation of fuel, low oxygen demand of the product gas, as well as allow for precise sulfur management.

In an embodiment, a method for chemical looping is provided. The method includes the steps of circulating a first oxygen carrier between a first oxidizer and a first reducer, circulating a second oxygen carrier between a second oxidizer and a second reducer, transporting a first gas stream produced via a reduction reaction in the first reducer from the first reducer to the second reducer, within the second reducer, capturing a gas species from the first gas stream, and recycling the gas species to the first reducer. In an embodiment, the step of capturing the gas species from the gas stream includes reducing the second oxygen carrier in the second reducer, including adsorbing the gas species with the second oxygen carrier. In an embodiment, the step of recycling the gas species to the first reducer includes, transporting the second oxygen carrier from the second reducer to the second oxidizer, oxidizing the second oxygen carrier in the second oxidizer, including desorbing the gas species, transporting a second gas stream containing the gas species to the first oxidizer, capturing the gas species from the second gas stream by oxidizing the first oxygen carrier in the first oxidizer, and transporting the first oxygen carrier from first oxidizer to the first reducer. In an embodiment, the gas species is sulfur dioxide. In an embodiment, the first oxygen carrier is a calcium-based oxygen carrier. In an embodiment, the first oxygen carrier is limestone. In an embodiment, the second oxygen carrier is limestone. In an embodiment, the second oxygen carrier is a metal oxide. In an embodiment, the second oxygen carrier may be ilmenite. In an embodiment, the method may also include the step of adjusting a circulation rate of the second oxygen carrier between the second oxidizer and the second reducer to control oxygen demand of and a discharge SO₂ concentration.

In another embodiment, a method for chemical looping is provided. The method includes the steps of circulating a first oxygen carrier between an oxidizer and a first reducer, circulating a second oxygen carrier between the oxidizer and a second reducer, transporting a first gas stream produced via a reduction reaction in the first reducer from the first reducer to the second reducer, within the second reducer, with the second oxygen carrier, capturing a gas species from the first gas stream, and transporting the second oxygen carrier from the second reducer to the oxidizer. In an embodiment, the gas species is sulfur dioxide. In an embodiment, the first oxygen carrier is the same as the second oxygen carrier, and the first oxygen carrier and the second oxygen carrier are limestone. In an embodiment, the method may further include the step of injecting a make-up of the second oxygen carrier into a flow of the second oxygen carrier from the oxidizer to the second reducer. In an embodiment, the method may also include the step of recycling a portion of the second oxygen carrier from the second reducer back to the second reducer. In an embodiment, the method may include the steps of capturing carbon dioxide from a product gas of the second reducer, and recycling at least a portion of the captured carbon dioxide to the second reducer. In an embodiment, the captured carbon dioxide is injected at a plurality of different locations within the second reducer.

In yet another embodiment, a system for chemical looping is provided. The system includes a first reducer in which a fuel reacts with a first oxygen carrier, a second reducer in fluid communication with the first reducer and receiving a combustion gas stream therefrom, and in which at least one gas species in the combustion gas stream reacts with a second oxygen carrier, and at least one oxidizer in fluid communication with the first reducer and the second reducer for supplying the first oxygen carrier to the first reducer and the second oxygen carrier to the second reducer after an oxidizing reaction in the oxidizer. In an embodiment, the at least one oxidizer includes a first oxidizer in fluid communication with the first reducer for supplying the first oxygen carrier to the first reducer and a second oxidizer in fluid communication with the second reducer for supplying the second oxygen carrier to the second reducer. In an embodiment, the first oxygen carrier is limestone, the second oxygen carrier is a metal oxide, and the at least one gas species includes sulfur dioxide.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method for chemical looping, comprising the steps of:
circulating a first oxygen carrier between a first oxidizer and a first reducer;
circulating a second oxygen carrier between a second oxidizer and a second reducer;
transporting a first gas stream produced via a reduction reaction in the first reducer from the first reducer to the second reducer;
within the second reducer, capturing a gas species from the first gas stream; and
recycling the gas species to the first reducer.

2. The method according to claim 1, wherein the step of capturing the gas species from the gas stream includes reducing the second oxygen carrier in the second reducer, including adsorbing the gas species with the second oxygen carrier.

3. The method according to claim 2, wherein the step of recycling the gas species to the first reducer includes:
transporting the second oxygen carrier from the second reducer to the second oxidizer;
oxidizing the second oxygen carrier in the second oxidizer, including desorbing the gas species;
transporting a second gas stream containing the gas species to the first oxidizer; and
capturing the gas species from the second gas stream by oxidizing the first oxygen carrier in the first oxidizer; and
transporting the first oxygen carrier from first oxidizer to the first reducer.

4. The method according to claim 3, wherein:
the gas species is sulfur dioxide.

5. The method according to claim 4, wherein:
the first oxygen carrier is a calcium-based oxygen carrier.

6. The method according to claim 5, wherein:
the first oxygen carrier is limestone.

7. The method according to claim 4, wherein:
the second oxygen carrier is limestone.

8. The method according to claim 4, wherein:
the second oxygen carrier is a metal oxide.

9. The method according to claim 8, wherein:
the second oxygen carrier is ilmenite.

10. The method according to claim 1, further comprising the step of:
adjusting a circulation rate of the second oxygen carrier between the second oxidizer and the second reducer to control oxygen demand of and a discharge SO₂ concentration.

11. A method for chemical looping, comprising the steps of:
circulating a first oxygen carrier between an oxidizer and a first reducer;
circulating a second oxygen carrier between the oxidizer and a second reducer;
transporting a first gas stream produced via a reduction reaction in the first reducer from the first reducer to the second reducer;
within the second reducer, with the second oxygen carrier, capturing a gas species from the first gas stream; and
transporting the second oxygen carrier from the second reducer to the oxidizer.

12. The method according to claim 11, wherein:
the gas species is sulfur dioxide.

13. The method according to claim 12, wherein:
the first oxygen carrier is the same as the second oxygen carrier; and
the first oxygen carrier and the second oxygen carrier are limestone.

14. The method according to claim 13, further comprising the step of:
injecting a make-up of the second oxygen carrier into a flow of the second oxygen carrier from the oxidizer to the second reducer.

15. The method according to claim 13, further comprising the step of:
recycling a portion of the second oxygen carrier from the second reducer back to the second reducer.

16. The method according to claim 13, further comprising the steps of:
capturing carbon dioxide from a product gas of the second reducer; and
recycling at least a portion of product gases which include unburnt reduced species to the second reducer.

17. The method according to claim 16, wherein:
recycling at least a portion of the captured carbon dioxide to the second reducer includes injecting the captured carbon dioxide at a plurality of different locations within the second reducer.

18. A system for chemical looping, comprising:
a first reducer in which a fuel reacts with a first oxygen carrier;
a second reducer in fluid communication with the first reducer and receiving a combustion gas stream therefrom, and in which at least one gas species in the combustion gas stream reacts with a second oxygen carrier; and
at least one oxidizer in fluid communication with the first reducer and the second reducer for supplying the first oxygen carrier to the first reducer and the second oxygen carrier to the second reducer after an oxidizing reaction in the oxidizer.

19. The system of claim 18, wherein:
the at least one oxidizer includes a first oxidizer in fluid communication with the first reducer for supplying the first oxygen carrier to the first reducer and a second oxidizer in fluid communication with the second reducer for supplying the second oxygen carrier to the second reducer.

20. The system of claim 19, wherein:
the first oxygen carrier is limestone;
the second oxygen carrier is a metal oxide; and
the at least one gas species includes sulfur dioxide.
